(19) United States
(12) Patent Application Publication
(10) Pub. No.: US 2014/0357319 A1
(43) Pub. Date: Dec. 4, 2014

(54) BEAMFORMING SYSTEM AND METHOD FOR MODULAR PHASED ANTENNA ARRAY

(71) Applicants: Alexander Maltsev, Nizhny Novgorod (RU); Ali Sadri, San Diego, CA (US); Richard Nichols, Santa Clara, CA (US); Vadim Sergeyev, Nizhny Novgorod (RU); Andrey Pudeyev, Nizhny Novgorod (RU); Alexei Davydov, Nizhny Novgorod (RU)

(72) Inventors: Alexander Maltsev, Nizhny Novgorod (RU); Ali Sadri, San Diego, CA (US); Richard Nichols, Santa Clara, CA (US); Vadim Sergeyev, Nizhny Novgorod (RU); Andrey Pudeyev, Nizhny Novgorod (RU); Alexei Davydov, Nizhny Novgorod (RU)

(21) Appl. No.: 14/126,516

(22) PCT Filed: Dec. 21, 2012
(86) PCT No.: PCT/RU2012/001098

§ 371 Date: Dec. 16, 2013

(51) Int. Cl. H04B 7/06; H04B 7/01

(52) U.S. Cl. CPC H04B 7/0667; H04B 7/01
USPC 455/562.1

(57) ABSTRACT

Generally, this disclosure provides systems and methods for modular antenna array beamforming with controllable antenna module delay for improved beam steering accuracy. A system may include a plurality of antenna modules, each of the antenna modules comprising an array of antenna elements coupled to an RF beamforming circuit, the RF beamforming circuit to adjust phase shifts associated with the antenna elements to generate an antenna beam associated with the antenna module; a delay circuit coupled to each of the antenna modules; and a central beamforming module coupled to each of the delay circuits, the central beamforming module to control the antenna beam associated with each of the antenna modules and further to adjust signal delays associated with the delay circuits, wherein the arrays of antenna elements of the antenna modules combine to operate as a composite antenna beamforming array.

The present disclosure relates to antenna array beamforming and, more particularly, to modular antenna array beamforming with improved steering accuracy for wideband signals.

### BACKGROUND

Electronic devices, such as laptops, notebooks, netbooks, personal digital assistants (PDAs) and mobile phones, for example, increasingly tend to include a variety of wireless communication capabilities operating at increased data rates. The wireless communication systems used by these devices are expanding into the higher carrier frequency ranges of the communication spectrum such as, for example, the millimeter wave region and, in particular, the 60 GHz band. However, propagation losses and attenuation increase at these higher frequencies, and it can become difficult to implement antenna systems in a manner that simultaneously provides the desired gain and spatial coverage.

Communication in this band at distances of approximately 50 meters or more (as, for example, outdoors or in large spaces) typically requires the use of highly directional antennas with gains greater than 30 dBi to compensate for the attenuation losses. Additionally, there is often a requirement for relatively wide sector coverage to include other devices and stations regardless of location. Some communication systems employ phased array beamforming to steer a relatively narrow beam in a desired direction. However, phased array antennas of the required size (for millimeter wave operation) impose limitations on the signal bandwidth. As the ratio of signal bandwidth to carrier frequency increases, the beam typically disperses and the desired “pencil-thin” beam may be transformed into an unsuitable wide angle beam.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one exemplary embodiment consistent with the present disclosure;

FIG. 2 illustrates a block diagram of one exemplary embodiment consistent with the present disclosure;

FIG. 3 illustrates a block diagram of another exemplary embodiment consistent with the present disclosure;

FIG. 4 illustrates signal characteristics associated with a phased array antenna;

FIG. 5 illustrates beam angle dispersion associated with a phased array antenna:

FIG. 6 illustrates a flowchart of operations of an exemplary embodiment consistent with the present disclosure; and

FIG. 7 illustrates a platform of one exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems and methods for modular antenna array beamforming with controllable antenna module delay for improved beam steering accuracy. The modular architecture enables the synthesis of larger composite antenna arrays from smaller sub-array antenna modules. A combination of radio frequency (RF) beamforming in the sub-array antenna modules and baseband beamforming between sub-array antenna modules provides increased beamforming capability. A controllable time delay module associated with each sub-array antenna module reduces beam dispersion. The system may be configured to operate in the millimeter wave (mm-wave) region of the RF spectrum and, in particular, the 60 GHz region associated with the use of, for example, wireless personal area network (WPAN) and wireless local area network (WLAN) communication systems.

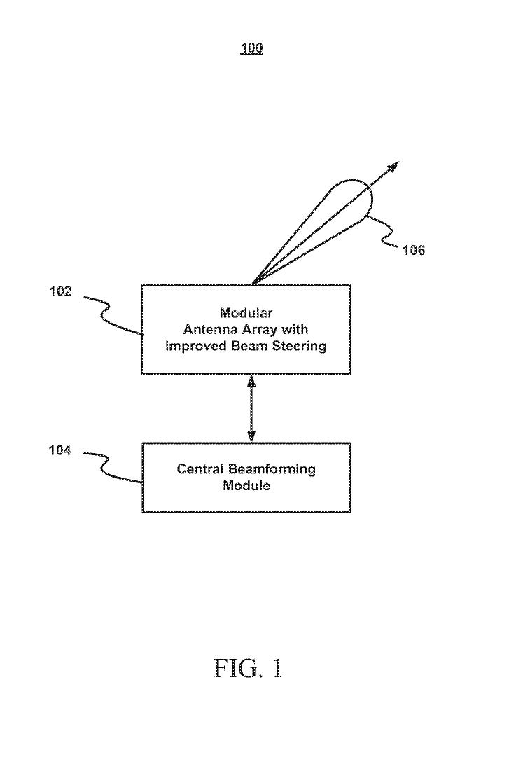

FIG. 1 illustrates a top level system diagram 100 of one exemplary embodiment consistent with the present disclosure. A modular antenna array with improved beam steering 102 is shown coupled to a central beamforming module 104, the operation of which will be described in greater detail below. The system may be configured to generate a steerable antenna beam pattern 106 and to transmit and/or receive data in the mm-wave region of the RF spectrum. In some embodiments the system may form part of a wireless communication platform such as, for example, a mobile phone, a laptop, a tablet or a base station.

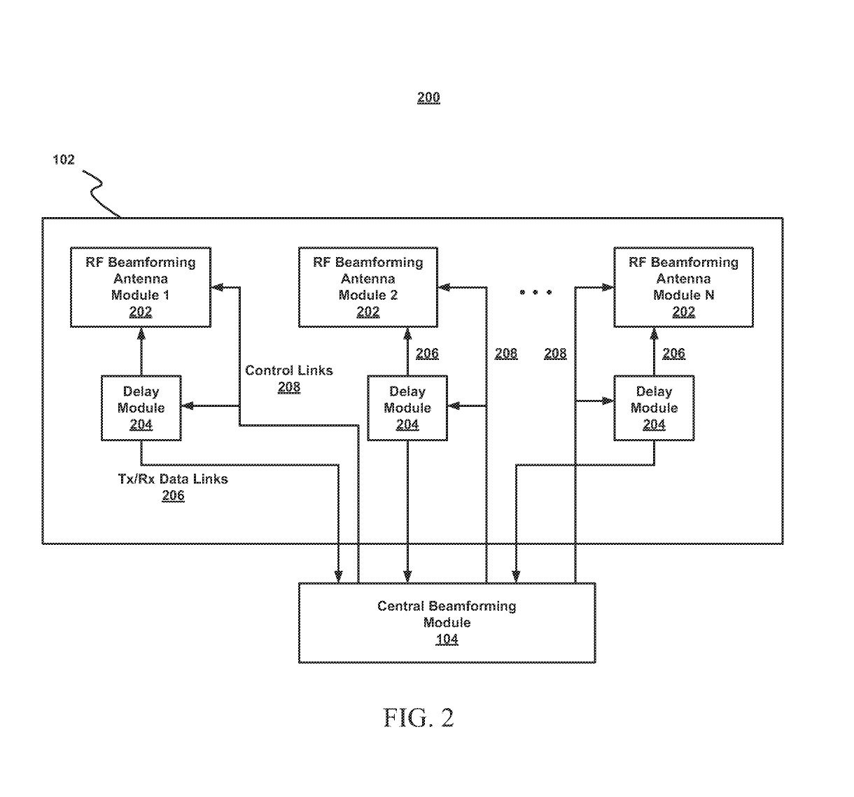

FIG. 2 illustrates a block diagram 200 of one exemplary embodiment consistent with the present disclosure. The example modular antenna array system 102 is shown to include a plurality of RF beamforming antenna modules 202 (sub-arrays) coupled, through controllable delay modules 204, to a central beamforming module 104 by transmit (Tx) and receive (Rx) data links 206. Control links 208 are provided between the central beamforming module 104 and the antenna modules 202 to control the generation and steering of the beam patterns. Control links 208 are also provided between the central beamforming module 104 and the delay modules 204 to adjust the signal delay to reduce dispersion of the beam, particularly for wideband signal. The signal delay adjustments may be based on antenna module geometry and/or steering angle as will be explained in greater detail below.

In some embodiments, the central beamforming module 104 may operate at baseband, intermediate frequency (IF) or at RF. The data to be transmitted or received by the system may be provided through a data port (not shown) that couples the central beamforming module 104 to a processor or any other suitable system configured to generate or receive data.

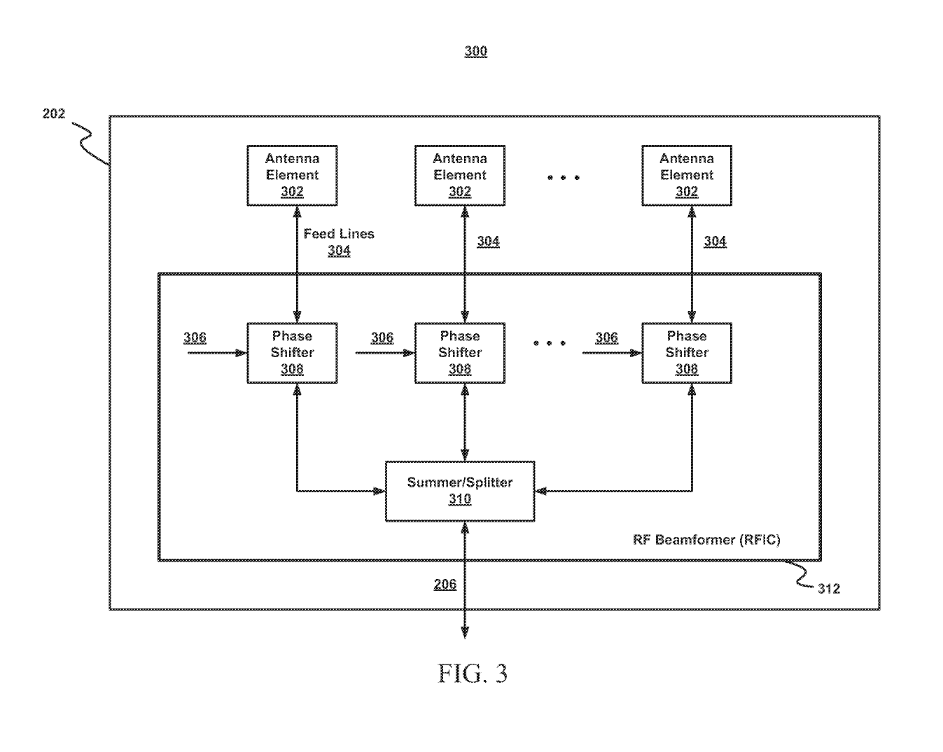

FIG. 3 illustrates a block diagram 300 of another exemplary embodiment consistent with the present disclosure. RF beamforming antenna modules 202 are shown to include an array of antenna elements 302 coupled to an RF beamformer radio frequency integrated circuit (RFIC) 312 through feed lines 304 which may be micro-strip feed lines. RFIC 312 includes an array of phase shifting circuits 308 coupled to a summer/splitter circuit 310. The phase shifter circuits 308 are configured to adjust the phase of the RF signal received from (or transmitted to) the associated antenna element 302. The amount of the phase shift may be determined by control signals 306 that are supplied to the phase shifter circuits. The control signals 306 may be weighting coefficients that are generated within the RFIC 312 and/or derived from signals on control links 208 received from the central beamforming module 104. The phase shift adjustments may determine and control the beam width, gain and/or direction of the antenna beam formed by the array of antenna elements 302. In the case of a received signal, the summer/splitter circuit 310 sums the received phase shifted signals and provides the sum to the central beamforming module 104 over data links 206 through controllable delay modules 204. In the case of a transmitted signal, the summer/splitter circuit 310 splits the signal provided from the central beamforming module 104 over data links 206 through controllable delay modules 204 and couples the split signal to each of the phase shifter circuits 308.

The signals on control links 206 received from the central beamforming module 104 may further adjust the weighting coefficients to cause the RF beamforming antenna modules 202 to perform as a single larger antenna array with increased beamforming capability compared to the individual RF beamforming antenna modules 202, as will be explained in greater detail below.

Frequency up-conversion and down-conversion (not shown) may be performed on the transmit and receive signals (respectively) to convert between baseband (or immediate frequency—(IF)) and RF. In a preferred embodiment, the up/down frequency conversion may be performed by a module included in the RFIC 312. In some other embodiments, the frequency conversion may be performed by a module deployed between the RFIC 312 and the central beamforming module 104.

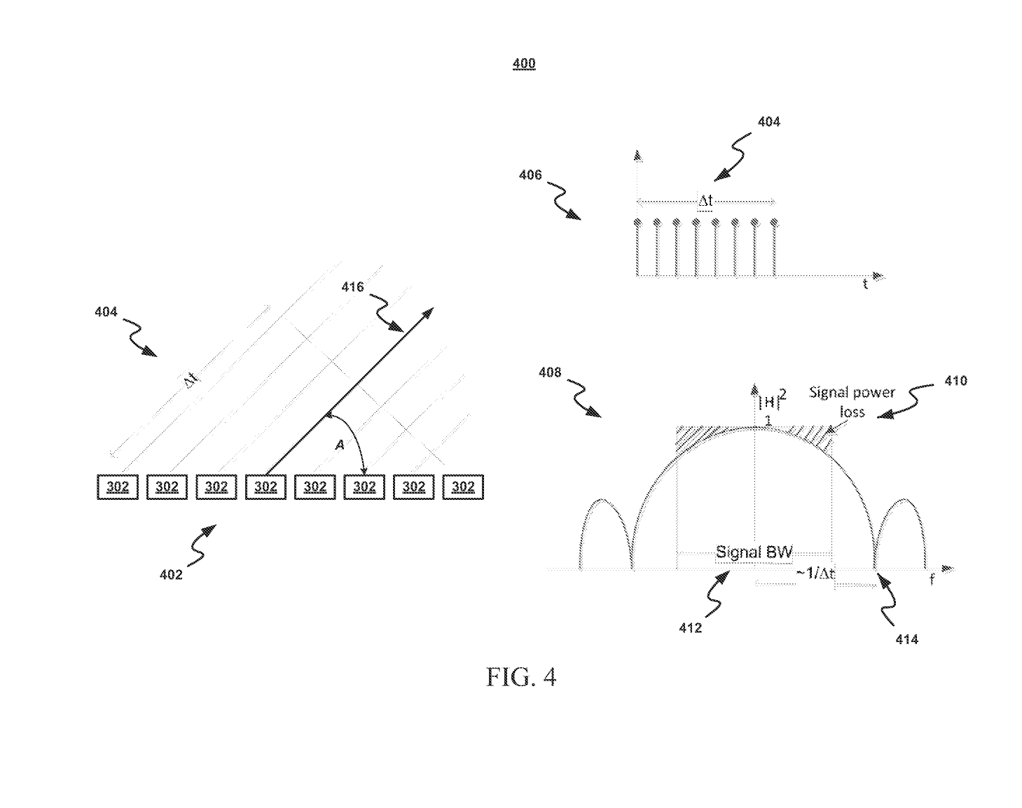

FIG. 4 illustrates signal characteristics 400 associated with a phased array antenna. In this example, antenna elements 302 are configured in a linear array 402 with a beam 416 that is steered at an angle A relative to the linear array. Different signal delays, up to a maximum Δt 404, result from the varying distances of the transmission path between each antenna element 302 and a remotely located receiver (not shown). This creates a time domain channel impulse response for the antenna array 406 that comprises a number of taps, corresponding to the number of antenna elements 302, spaced over the range 0 to Δt 404. This impulse response corresponds to a frequency domain channel transfer function 408 with a first zero 414 in the squared magnitude located at a frequency of approximately 1/Δt. It can be seen that as the signal bandwidth 412 increases (approaching the zero point 414), the signal power loss 410 increases, resulting in degradation of the antenna gain in the direction of the main lobe of the antenna beam as the channel transfer function can no longer be assumed to be flat within the signal bandwidth 412. Similarly, as the aperture of the antenna array increases (in this case the length of the linear array), the value of Δt 404 increases, and the associated frequency selectivity of the channel increases as the zero point 414 moves closer to the center frequency of the signal.

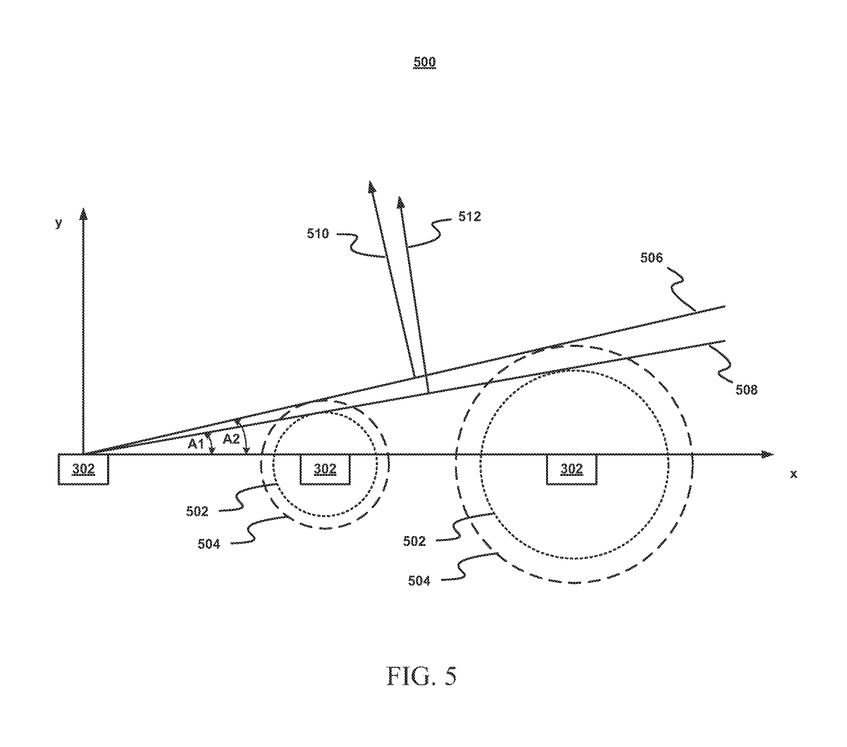

Thus, traditional phased array antennas are subject to limitations on the bandwidth of the signal for which a beam may be efficiently steered. Specifically it can be shown that the approximate relation between signal bandwidth (relative to the carrier frequency) that can be efficiently steered and antenna aperture can be expressed as follows:

$$\frac{Δ f}{f} << \frac{λ}{A} = \frac{1}{N} ,$$

where Δf is the signal bandwidth, f is the carrier frequency, λ is the signal carrier wavelength, A is the antenna aperture size and N is the number of wavelengths that fit in the aperture. If the beam to be steered carries a signal with a ratio of bandwidth to carrier frequency that exceeds this limit, the resulting beam dispersion, as different frequency components are steered to different angles, will degrade system performance. This phenomenon is further illustrated in FIG. 5 which shows the beam angle dispersion 500 associated with a phased array antenna. The phased array antenna comprises a linear array of antenna elements 302, only three of which are presented for simplicity. A signal is radiated through the phased array antenna, and the phases of the phase shifters are set in accordance with a linear distribution calculated to steer the beam in a desired direction. Each antenna element 302 is shown to emit a high frequency wave component 502 and a low frequency wave component 504. The high frequency wave component 502 may represent the high frequency end of the signal bandwidth while the low frequency wave component 504 may represent the low frequency end of the signal bandwidth. Since the wavelength of the lower frequency signal component is greater than that of the higher frequency component, the travel distance corresponding to the same phase will also be greater for the lower frequency signal component. This will result in the wave front 506 corresponding to the lower frequency signal to steer at a greater angle, A2, than the wave front 508 corresponding to the higher frequency signal which steers at angle A1. The corresponding lower frequency beam direction 510 is therefore displaced from the higher frequency beam direction 512 by the difference between angles A1 and A2 resulting in beam dispersion.

One approach to solving this problem is to align the wave fronts by substituting adjustable delay blocks for the phase shifters 308 associated with each antenna element 302 in the RFIC 312. This works since the signal travel distance is directly proportional to the time delay and does not depend on wavelength or frequency. This solution is prohibitively expensive, however, due to the complexity of implementing an adjustable delay module at the high resolutions associated with mm-wave frequency bands and providing that delay module for each antenna element in a very large antenna array.

As an alternative, embodiments of the present disclosure employ a single adjustable delay module 204 between each antenna module sub-array 202 and the central beamforming module 104 which significantly reduces the number of delay modules and the cost of the system. The signals are delayed by a value that is based on the desired beam steering angle and the geometry of the array. In some embodiments, the delay value for each antenna module 202 may be calculated as

dT=n*L*sin(A)/c,

where n is the antenna module index (i.e., 0, . . . N−1 for N modules), L is the distance between antenna modules, A is the steering angle and c is the speed of light. This approach may reduce the total system channel delay spread to value more closely associated with the delay spread of a single antenna module sub-array. Total system beam dispersion may similarly be reduced with the dispersion being inversely proportional to the number of antenna module sub-arrays deployed in the composite array.

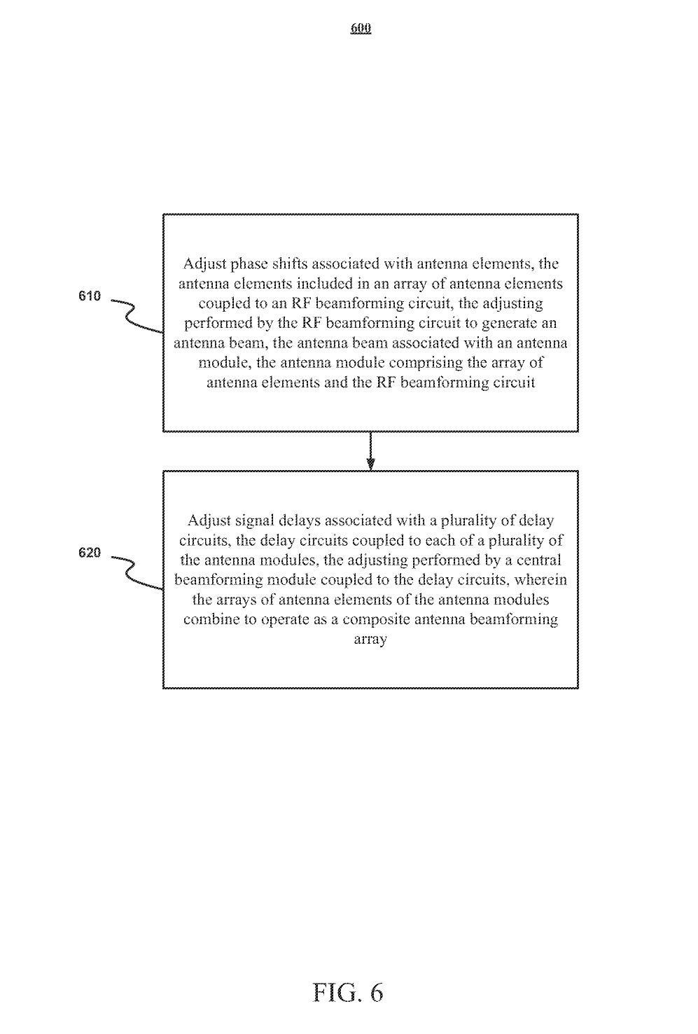

FIG. 6 illustrates a flowchart of operations 600 of an exemplary embodiment consistent with the present disclosure. At operation 610, phase shifts associated with antenna elements are adjusted. The antenna elements are included in an array of antenna elements coupled to an RF beamforming circuit and the adjusting is performed by the RF beamforming circuit to generate an antenna beam associated with an antenna module. The antenna module includes the array of antenna elements and the RF beamforming circuit. At operation 620, signal delay associated with a plurality of delay circuits is adjusted, the delay circuits coupled to each of a plurality of the antenna modules. The adjusting is performed by a central beamforming module coupled to the delay circuits, wherein the arrays of antenna elements of the antenna modules combine to operate as a composite antenna beamforming array.

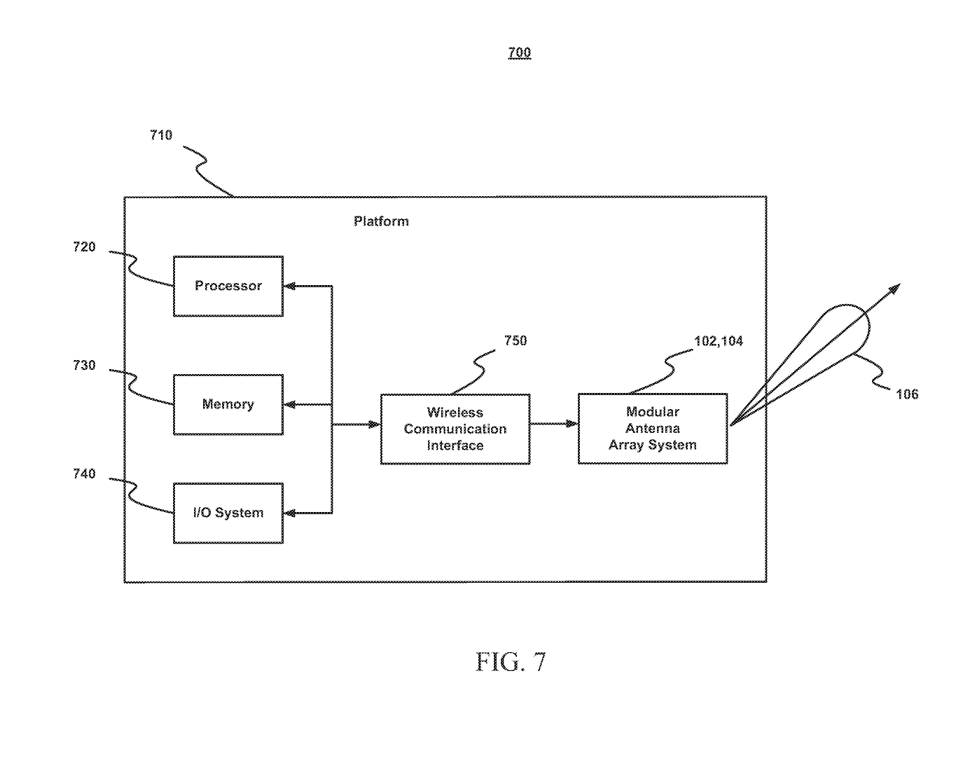

FIG. 7 illustrates a platform 700 of one exemplary embodiment consistent with the present disclosure. Platform 710 may be a mobile communication device such as, for example, a smartphone, a tablet, a laptop computing device or any other device configured to transmit or receive wireless signals. In some embodiments, platform 710 may be a wireless base station. Platform 710 may include a processor 720, memory 730, an input/output (I/O) system 740, a wireless communication interface 750 and a modular antenna array system 102, 104. The modular antenna array system 102, 104 may be configured to generate an antenna beam pattern 106 in a desired direction, with improved steering accuracy as described previously. Any number of platforms 710 may transmit or receive signals through a wireless network or any suitable communication medium.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination as would be understood by one skilled in the art. Thus, not all of the operations of each of the flowcharts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk re-writables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry,” as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides systems, methods and platforms for modular antenna array beamforming with controllable antenna module delay for improved beam steering accuracy.

The system may include a plurality of antenna modules, each of the antenna modules including an array of antenna elements coupled to an RF beamforming circuit, the RF beamforming circuit to adjust phase shifts associated with the antenna elements to generate an antenna beam associated with the antenna module. The system of this example may also include a delay circuit coupled to each of the antenna modules. The system of this example may further include a central beamforming module coupled to each of the delay circuits, the central beamforming module to control the antenna beam associated with each of the antenna modules and further to adjust signal delays associated with the delay circuits, and the arrays of antenna elements of the antenna modules combine to operate as a composite antenna beamforming array.

Another example system includes the forgoing components and the central beamforming module is further to control the composite antenna beamforming array to generate a composite antenna beam, the composite antenna beam having a higher gain and narrower beamwidth than the antenna beams associated with the antenna modules.

Another example system includes the forgoing components and the central beamforming module is further to control the composite antenna beamforming array to generate a composite antenna beam, the composite antenna beam having a wider beamwidth than the antenna beams associated with the antenna modules.

Another example system includes the forgoing components and the central beamforming module is further to control the composite antenna beamforming array to generate a composite antenna beam and to steer the composite antenna beam from a first direction to a second direction.

Another example system includes the forgoing components and the signal delay adjustments are based on a beam steering direction of the composite antenna beam.

Another example system includes the forgoing components and the central beamforming module is included in a baseband processor, an intermediate frequency processor or an RF processor.

Another example system includes the forgoing components and the RF beamforming circuits are RFICs and the antenna modules are to operate in a millimeter wave frequency range.

Another example system includes the forgoing components and the antenna elements are coupled to the RF beamforming circuit by micro-strip feeding lines.

According to another aspect there is provided a method. The method may include adjusting phase shifts associated with antenna elements, the antenna elements included in an array of antenna elements coupled to an RF beamforming circuit, the adjusting performed by the RF beamforming circuit to generate an antenna beam, the antenna beam associated with an antenna module, the antenna module including the array of antenna elements and the RF beamforming circuit. The method of this example may also include adjusting signal delays associated with a plurality of delay circuits, the delay circuits coupled to each of a plurality of the antenna modules, the adjusting performed by a central beamforming module coupled to the delay circuits, and the arrays of antenna elements of the antenna modules combine to operate as a composite antenna beamforming array.

Another example method includes the forgoing operations and further includes controlling the composite antenna beamforming array to generate a composite antenna beam, the composite antenna beam having a higher gain and narrower beamwidth than the antenna beams associated with the antenna modules.

Another example method includes the forgoing operations and further includes controlling the composite antenna beamforming array to generate a composite antenna beam, the composite antenna beam having a wider beamwidth than the antenna beams associated with the antenna modules.

Another example method includes the forgoing operations and further includes controlling the composite antenna beamforming array to generate a composite antenna beam and to steer the composite antenna beam from a first direction to a second direction.

Another example method includes the forgoing operations and the signal delay adjusting is based on a beam steering direction of the composite antenna beam.

Another example method includes the forgoing operations and the central beamforming module is included in a baseband processor, an intermediate frequency processor or an RF processor.

According to another aspect there is provided a platform. The platform may include a processor; an input/output module coupled to the processor; a memory coupled to the processor; and a wireless communication interface coupled to the processor. The wireless communication interface of this example may include a plurality of antenna modules each of the antenna modules including an array of antenna elements coupled to an RF beamforming circuit, the RF beamforming circuit to adjust phase shifts associated with the antenna elements to generate an antenna beam associated with the antenna module. The wireless communication interface of this example may also include a delay circuit coupled to each of the antenna modules. The wireless communication interface of this example may further include a central beamforming module coupled to each of the delay circuits, the central beamforming module to control the antenna beam associated with each of the antenna modules and further to adjust signal delays associated with the delay circuits, and the arrays of antenna elements of the antenna modules combine to operate as a composite antenna beamforming array.

Another example platform includes the forgoing components and the central beamforming module is further to control the composite antenna beamforming array to generate a composite antenna beam, the composite antenna beam having a higher gain and narrower beamwidth than the antenna beams associated with the antenna modules.

Another example platform includes the forgoing components and the central beamforming module is further to control the composite antenna beamforming array to generate a composite antenna beam, the composite antenna beam having a wider beamwidth than the antenna beams associated with the antenna modules.

Another example platform includes the forgoing components and the central beamforming module is further to control the composite antenna beamforming array to generate a composite antenna beam and to steer the composite antenna beam from a first direction to a second direction.

Another example platform includes the forgoing components and the signal delay adjustments are based on a beam steering direction of the composite antenna beam.

Another example platform includes the forgoing components and the central beamforming module is included in a baseband processor, an intermediate frequency processor or an RF processor.

Another example platform includes the forgoing components and the RF beamforming circuits are included in one or more RFICs and the antenna modules are to operate in a millimeter wave frequency range.

Another example platform includes the forgoing components and the antenna elements are coupled to the RF beamforming circuit by micro-strip feeding lines.

Another example platform includes the forgoing components and the platform is a smartphone, a laptop computing device or a tablet.

Another example platform includes the forgoing components and the platform is a wireless base station.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-29. (canceled)

30. A system for antenna beamforming, said system comprising:
a plurality of antenna modules, each of said antenna modules comprising an array of antenna elements coupled to a radio frequency (RF) beamforming circuit, said RF beamforming circuit to adjust phase shifts associated with said antenna elements to generate an antenna beam associated with said antenna module;
a delay circuit coupled to each of said antenna modules; and
a central beamforming module coupled to each of said delay circuits, said central beamforming module to control said antenna beam associated with each of said antenna modules and further to adjust signal delays associated with said delay circuits, wherein said arrays of antenna elements of said antenna modules combine to operate as a composite antenna beamforming array.

31. The system of claim 30, wherein said central beamforming module is further to control said composite antenna beamforming array to generate a composite antenna beam, said composite antenna beam having a higher gain and narrower beamwidth than said antenna beams associated with said antenna modules.

32. The system of claim 30, wherein said central beamforming module is further to control said composite antenna beamforming array to generate a composite antenna beam, said composite antenna beam having a wider beamwidth than said antenna beams associated with said antenna modules.

33. The system of claim 30, wherein said central beamforming module is further to control said composite antenna beamforming array to generate a composite antenna beam and to steer said composite antenna beam from a first direction to a second direction.

34. The system of claim 33, wherein said signal delay adjustments are based on a beam steering direction of said composite antenna beam.

35. The system of claim 30, wherein said central beamforming module is included in a processor selected from the group consisting of a baseband processor, an intermediate frequency processor and an RF processor.

36. The system of claim 30, wherein said RF beamforming circuits are RF integrated circuits (RFICs) and said antenna modules are to operate in a millimeter wave frequency range.

37. The system of claim 30, wherein said antenna elements are coupled to said RF beamforming circuit by micro-strip feeding lines.

38. A method for antenna beamforming, said method comprising:
adjusting phase shifts associated with antenna elements, said antenna elements included in an array of antenna elements coupled to an RF beamforming circuit, said adjusting performed by said RF beamforming circuit to generate an antenna beam, said antenna beam associated with an antenna module, said antenna module comprising said array of antenna elements and said RF beamforming circuit; and
adjusting signal delays associated with a plurality of delay circuits, said delay circuits coupled to each of a plurality of said antenna modules, said adjusting performed by a central beamforming module coupled to said delay circuits, wherein said arrays of antenna elements of said antenna modules combine to operate as a composite antenna beamforming array.

39. The method of claim 38, further comprising controlling said composite antenna beamforming array to generate a composite antenna beam, said composite antenna beam having a higher gain and narrower beamwidth than said antenna beams associated with said antenna modules.

40. The method of claim 38, further comprising controlling said composite antenna beamforming array to generate a composite antenna beam, said composite antenna beam having a wider beamwidth than said antenna beams associated with said antenna modules.

41. The method of claim 38, further comprising controlling said composite antenna beamforming array to generate a composite antenna beam and to steer said composite antenna beam from a first direction to a second direction.

42. The method of claim 41, wherein said signal delay adjusting is based on a beam steering direction of said composite antenna beam.

43. The method of claim 38, wherein said central beamforming module is included in a processor selected from the group consisting of a baseband processor, an intermediate frequency processor and an RF processor.

44. A platform comprising:
a processor;
an input/output module coupled to said processor;
a memory coupled to said processor; and
a wireless communication interface coupled to said processor, said interface comprising:
a plurality of antenna modules, each of said antenna modules comprising an array of antenna elements coupled to a radio frequency (RF) beamforming circuit, said RF beamforming circuit to adjust phase shifts associated with said antenna elements to generate an antenna beam associated with said antenna module;
a delay circuit coupled to each of said antenna modules; and
a central beamforming module coupled to each of said delay circuits, said central beamforming module to control said antenna beam associated with each of said antenna modules and further to adjust signal delays associated with said delay circuits, wherein said arrays of antenna elements of said antenna modules combine to operate as a composite antenna beamforming array.

45. The platform of claim 44, wherein said central beamforming module is further to control said composite antenna beamforming array to generate a composite antenna beam, said composite antenna beam having a higher gain and narrower beamwidth than said antenna beams associated with said antenna modules.

46. The platform of claim 44, wherein said central beamforming module is further to control said composite antenna beamforming array to generate a composite antenna beam, said composite antenna beam having a wider beamwidth than said antenna beams associated with said antenna modules.

47. The platform of claim 44, wherein said central beamforming module is further to control said composite antenna beamforming array to generate a composite antenna beam and to steer said composite antenna beam from a first direction to a second direction.

48. The platform of claim 47, wherein said signal delay adjustments are based on a beam steering direction of said composite antenna beam.

49. The platform of claim 44, wherein said central beamforming module is included in a processor selected from the group consisting of a baseband processor, an intermediate frequency processor and an RF processor.

50. The platform of claim 44, wherein said RF beamforming circuits are included in one or more RF integrated circuits (RFICs) and said antenna modules are to operate in a millimeter wave frequency range.

51. The platform of claim 44, wherein said antenna elements are coupled to said RF beamforming circuit by micro-strip feeding lines.

52. The platform of claim 44, wherein said platform is selected from the group consisting of a smartphone, a laptop computing device and a tablet.

53. The platform of claim 44, wherein said platform is a wireless base station.

54. A computer-readable storage medium having instructions stored thereon which when executed by a processor result in the following operations for antenna beamforming, said operations comprising:
adjusting phase shifts associated with antenna elements, said antenna elements included in an array of antenna elements coupled to an RF beamforming circuit, said adjusting performed by said RF beamforming circuit to generate an antenna beam, said antenna beam associated with an antenna module, said antenna module comprising said array of antenna elements and said RF beamforming circuit; and
adjusting signal delays associated with a plurality of delay circuits, said delay circuits coupled to each of a plurality of said antenna modules, said adjusting performed by a central beamforming module coupled to said delay circuits, wherein said arrays of antenna elements of said antenna modules combine to operate as a composite antenna beamforming array.

55. The computer-readable storage medium of claim 54, further comprising the operations of controlling said composite antenna beamforming array to generate a composite antenna beam, said composite antenna beam having a higher gain and narrower beamwidth than said antenna beams associated with said antenna modules.

56. The computer-readable storage medium of claim 54, further comprising the operations of controlling said composite antenna beamforming array to generate a composite antenna beam, said composite antenna beam having a wider beamwidth than said antenna beams associated with said antenna modules.

57. The computer-readable storage medium of claim 54, further comprising the operations of controlling said composite antenna beamforming array to generate a composite antenna beam and to steer said composite antenna beam from a first direction to a second direction.

58. The computer-readable storage medium of claim 57, wherein said signal delay adjusting is based on a beam steering direction of said composite antenna beam.
